(19) United States
(12) Patent Application Publication
(10) Pub. No.: US 2001/0050449 A1
(43) Pub. Date: Dec. 13, 2001

(54) Solar powered crayon recycling toy

(76) Inventor: Keith M. Baxter, Brookfield, WI (US)

Correspondence Address: Keith M. Baxter, Quarles & Brady LLP, 411 East Wisconsin Ave., Suite 2040, Milwaukee, WI, 53202-4497, US

(21) Appl. No.: 09/760,416

(22) Filed: Jan. 11, 2001

Related U.S. Application Data
(60) Provisional application No. 60/175,809, filed on Jan. 12, 2000.

(51) Int. Cl. B29C 35/08; B29C 33/30; B29C 33/06

(52) U.S. Cl. 264/402; 425/803; 249/79; 249/134; 249/139; 264/911

(57) ABSTRACT

A wax molding toy uses a heat retaining housing with a transparent surface to provide wax melting temperatures with typical indoor solar flux intensities.

### CROSS-REFERENCE TO RELATED APPLICATIONS

This application is based on U.S. Provisional filing No. 60/175,809 filed Jan. 12, 2000 and claims the benefit thereof.

### BACKGROUND OF THE INVENTION

The present invention relates to children's crayons and, in particular, to a device for sharpening and reforming broken or dull crayons using heat from the sun.

Children's crayons employ a binder of wax to carry a non-toxic colored pigment. Although crayons offer a versatile and safe media for children, they have several drawbacks. The first is that the wax matrix is relatively soft so the crayon tip rapidly dulls. Further the crayon is easily broken, especially once the outer paper wrapper is removed.

Mechanical sharpeners may be used to sharpen crayons. One form employs a canted blade hidden in a cavity. The crayon is sharpened by inserting the tip of the crayon into the cavity and rotating it against the blade. Repeated sharpenings reduce the length of the already short crayon, limiting the number of times the crayon can be resharpened.

It has been proposed to sharpen crayons with a heated conical cavity. The crayon tip is pressed against the cavity, which melts its surface into a point. Whether or not such devices are practical, they are relatively expensive and require both a connection to an electrical source and the use of a heating element, both of which may be make the device unsuitable for young children. In any case, the drawback to mechanical sharpening, that of the crayon getting shorter, is not avoided.

### BRIEF SUMMARY OF THE INVENTION

The present invention provides a safe, entertaining and educational way to sharpen dull crayons and to mold crayon fragments into complete crayons using single or multiple colors. The need for electricity or dangerous heat source is eliminated by a design that uses sunlight passing through a window as the sole energy source. While the sun provides sufficient heat to melt the crayons, the total amount of energy remains relatively small ensuring that the molten wax presents relatively little danger to a child both in temperature and heat capacity.

A device for practicing the invention may be inexpensively molded from a clear plastic such as polystyrene and may assembled from two molded mirror image shells so as to reduce molding costs. The shells may be held together by rubber bands to provide a safe and effective clamping. A suction cup may be used to hang the shells directly on a window eliminating the need for a nearby table or other support. The necessary insulation may be provided solely by air gaps within the shells eliminating the need for insulating foam or the like.

The crayons may be formed in an elastomeric mold flexing to provide for easy release of the molded crayons. Interlocking ridges and sockets flexibly engage to provide a good seal against leakage of molten wax during operation. The mold may be longer than a standard crayon to accommodate the inevitable gaps between the fragments from which the crayons are molded and thus to produce a crayon of full length. The mold may provide an internal ridge to allow excess sprue to be snapped off.

A temperature sensor composed of a liquid crystal device or a trap holding a fragment of wax may provide an indication of the temperature of the system.

By orienting the broad face of the toy vertically, year round use may be provided in which low angled sun provides more direct illumination during winter months and high angled sun has a high angle of incidence, which reduces its heating effect.

The entire toy may be readily formed by vacuforming or thermoforming techniques. A single piece thermoform shell may be used in conjunction with thermoformed front and rear panels to provide the necessary insulating and light transmitting properties or simple thermoformed shells may be used in combination with an opaque or other shroud. Molds may be thermoformed trays positioned so as to eliminate the need for tight sealing against the liquid wax. Forms other than crayons may also be formed such as medallions or the like.

### BRIEF DESCRIPTION OF THE DRAWINGS

FIG. 1 is a perspective view of the toy of the present invention supported via a suction cup and hook on the inside face of a window;

FIG. 2 is an exploded perspective view of the toy of FIG. 1 showing hooks by which the components of the toy are held together with elastic bands;

FIG. 3 is a cross-section taken along line 3-3 of FIG. 2 of the assembled toy showing the sandwiching of an elastomeric mold within transparent opposed insulating shells;

FIG. 4 is a detailed cross-section perpendicular to the cross-section of FIG. 3 showing a score line incorporated into the mold to facilitate the removal of the crayons sprue after molding;

FIG. 5 is a cross-sectional view similar to that of FIG. 3 showing a cavity in the mold for supporting a temperature indicating material between the mold and one panel of the shell;

FIG. 6 is a side elevational view of an alternative embodiment formed from a thermoformed tri-fold having laminated front and rear panels to provide for a double pane construction;

FIG. 7 is a front elevational view of the embodiment of FIG. 6 when assembled showing placement of thermoformed tray molds within the cavity so produced; and

FIG. 8 is a vertical cross section of the embodiment of FIG. 6 as placed against a window and having an opaque covering shroud in lieu of the front and back panels.

### DETAILED DESCRIPTION OF THE INVENTION

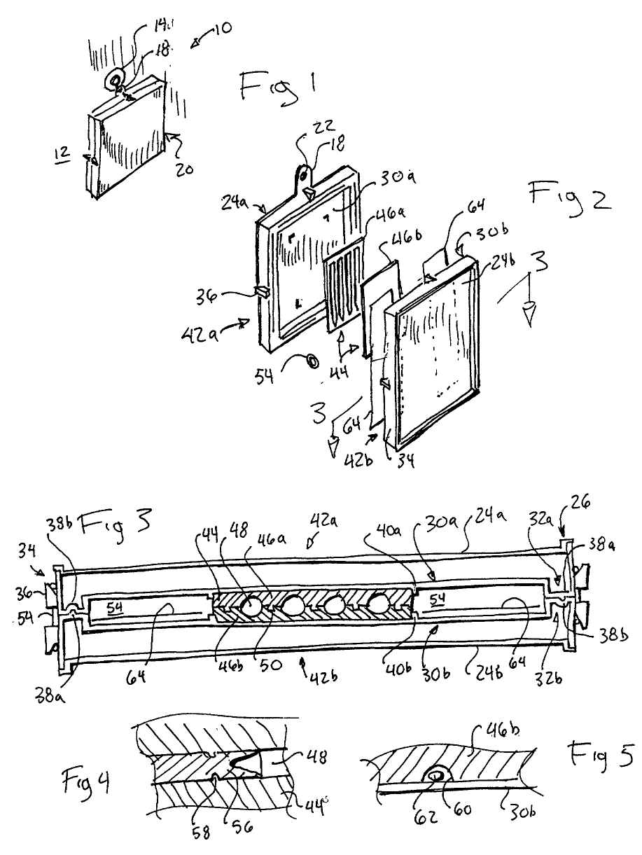

Referring now to FIG. 1, the molding toy 10 of the present invention has a generally rectangular body 20 such as may lie against an inner surface of a vertically oriented residential glass window 12 as held by a vinyl suction cup 14 having a metal hook. The hook of the suction cup may attach to an upwardly extending ear 18 positioned at a front edge of the body 20 and having a hole 22 for receiving the hook therethrough. A window-facing portion of the body 20 is transparent to allow sunlight to pass through to its inner volume.

Referring now to FIG. 2, the ear 18 may be an extension of a front cover plate 24a being generally a six-inch rectangle of 0.055-inch polystyrene plastic. The front cover plate 24a, as shown in FIG. 3, includes an offset lip 26 allowing it to fit into an open face of generally rectangular front mold support 30a. The front mold support 30 (when it is installed on the front cover plate 24a), presents a central face behind and parallel to the front cover plate 24a approximately 0.4 inches away from the front surface of front mold support 30a.

The central face of the front mold support 30 is in turn surrounded on four sides by channel 32 extending away from the front cover plate 24a. The channel 32 is in turn surrounded by walls 34 extending toward the front cover plate 24a and engaging its offset lip 26. The walls 34 thus support the front cover plate 24a. Front cover plate 24a and front mold support 30a may both be molded of the same polystyrene.

The front cover plate 24a and front mold support 30a, when assembled, form a shell 42a enclosing an airtight volume. A second identical shell 42b formed by rear cover plate 24b and rear mold support 30b may be rotated 180 degrees with respect to its vertical axis so that a now front facing surface of channel 32b of shell 42b (corresponding to channel 32a of shell 42a) abuts the rear facing surface of channel 32a of shell 42a. The rear facing surface of the channel 32a and the front facing surface of channel 32b include a key and socket joint 38 having interengaging portions extending in or out of surfaces to align the shells 42a and 42b for assembly. In this joint, keys 38a of one-half of the perimeter of the channel 32a engaging the sockets 38b on an opposite one half of the perimeter of the channel 32b of sides of the shell 42b and key sockets 38b of the remaining-half of the perimeter of the channel 32a engaging the keys 38a on a remaining opposite one half of the perimeter of the channel 32b of sides of the shell 42b. In this way the shells 42a and 42b can be identical.

The outer surfaces of the walls 34 of each of the shells 42a and 42b have outwardly extending hooks 36 such as may engage elastic bands 54 to hold the shells 42a and 42b together. The necessary pressure between the plate shells 42a and 42b may be adjusted by providing additional hooks 36 and elastic bands 54 as needed. Reinforcing ribs may be added to either of the front or rear cover plates 24 and mold support 30a or 30b to provide for additional rigidity in the body 20.

When assembled together, front mold support 30a of shell 42a and the corresponding rear mold support 3b of shell 42b are separated by their respective channels 32a and 32b to enclose an inner volume 51. Extending into this volume from the mold supports 30a and 30b are guide ridges 40a and 40b, respectively, aligning and supporting an elastomeric mold 44.

The elastomeric mold 44 may be constructed of an opaque rubber material such as silicone rubber and may separate into a front mold half 47a and a rear mold half 47b. The front mold half 47a and rear mold half 47b join along a vertical interface to define four crayon-shaped mold cavities 48, each being substantially 0.3 inches in diameter and 4.0 inches long to be approximately half an inch longer than a commercially available wax crayon but of equal diameter. The mold cavities terminate in a frusto-conical tip of the type adopted by commercial crayon manufacturers.

Troth and ridge joints 50 are positioned around each of the mold cavities 48 to prevent the migration of molten wax from one cavity to the other or into the volume between front mold support 30a and rear mold support 30b.

In use, fragments of crayons or crayons in need of sharpening are placed within the mold cavities 48 which are then clamped between the shells 42a and 42b as held by elastic bands 54 on each of four sides of the shells 42a and 42b. The assembled molding toy 10 is then placed on the window 12 as supported by the suction cup 14.

Approximately one hour of noonday sun will melt the contents of the elastomeric mold 44 causing the molten wax to descend toward the frusto-conical tips of the mold cavities 48 of elastomeric mold 44 which are preferably pointed downward.

Referring now to FIG. 4, some separation of the pigment from the wax matrix will cause a concentration of pigment toward the tip rendering an upper sprue 56 substantially free of pigment. The portion of the mold cavity 48 below the sprue 56 conforms substantially to the outline of a standard wax crayon 3.5 inches in length and includes beyond that point an inwardly extending annular ridge 58 which produces a circumferential groove between the sprue 56 and the remainder of the crayon to provide a point at which the sprue may snapped off. A circular bore (not shown) may be provided in one of the shells or both of the shells 42a and 42b to provide leverage for this snapping operation.

Referring now to FIG. 5, a portion of one of the mold halves 46a or 46b may have a concave depression 60 to form a pocket between the mold 46b and rear mold support 30b that may be used to hold a fragment of crayon 62 whose melting will indicate the temperature of the elastomeric mold 44. Likewise a thermometer or liquid crystal-type display may be placed at this point.

Black paper collectors 64 may be placed within the volume between the shells 42a and 42b so as to provide additional heat absorbing capacity in winter months.

The side of the collectors 64 toward the sun may be black and the side away from the sun may be a low emissivity surface such as white or foil.

It will be understood that the elastomeric mold 44 may be used to make other shapes as well as conventional crayons out of wax and thus the toy forms a general purpose-molding device.

Standoffs (not shown) may be molded into the front and rear cover plates 24a and 24b to hold the toy 10 away from the window during periods of low outside temperature so as to provide an additional insulating layer between the toy 10 and the window 12.

Instead of a two-part elastomeric mold 44, the mold may comprise sleeves of highly elastic material that may be rolled back without seam to release the crayons.

Alternatively, only the tips of the crayons may be molded using a small elastomeric mold and reusable handles embedded in the molten tips by projecting hooks. A high expansion co-efficient of these hooks would ensure the wax tips are held in tension against the handles, a mode of great strength for wax.

As an alternative to the elastomer, the molds may be formed directly out of a rigid plastic or semi-rigid plastic with a suitable release surface or having a sufficient flexure to allow release of the molded crayons. Sleeves may be provided to roll about the crayons when they are formed or may be molded in place. Different colored crayons may be put into the molds to provide for various effects including streaking and/or laminated crayons of different colors depending on the mobility of the pigments.

Referring now to FIG. 6, in an alternative embodiment of the molding toy 10, a thermoformed tri-fold shell 70 of a type well known in the art, may provide two outwardly concave shells 72 and 74 joined at lower outer edges 76 by means of living hinge members 76 to a base 78 so that bottom surfaces 80 of the shells 72 and 74 may hinge together and be held abutting by post and socket members 82 of a type well known in the art of thermoforming.

The abutting bottom surfaces 80 may be formed to produce inwardly facing cavities 84 such as may enclose molds 86 for holding crayon or other wax fragments.

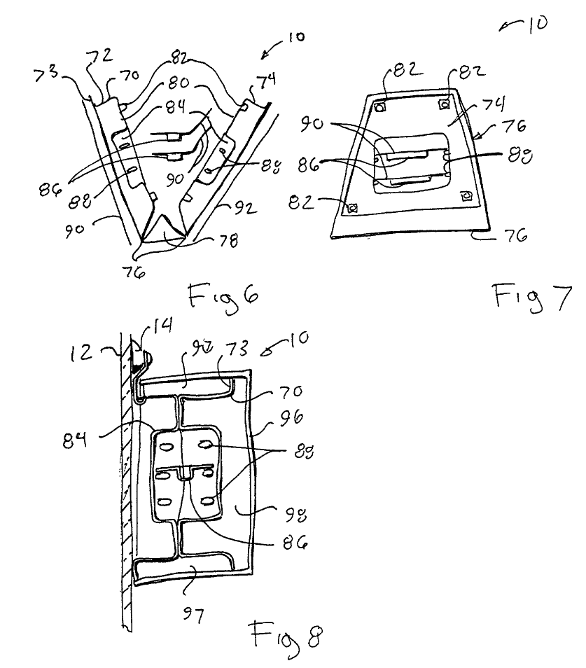

Referring now also to FIG. 7, the thermoformed material may be a transparent material to provide for the necessary influx of solar energy. Extending laterally inward from the sidewalls of the cavities 84 may be rails 88 also thermoformed as support the edges of the molds 86.

Referring again to FIG. 6, the molds 86 may have covering flaps 90 such as provide additional heat retention and are transparent to allow the influx of solar energy.

Transparent front plates and rear plates 90 and 92 may be adhered to the outwardly facing lips of shells 72 and 74 to trap air about the cavities 84 so as to reduce heat loss.

Referring now to FIG. 8, in an alternative embodiment, the tri-fold 70 of FIG. 6 may be used without front and rear plates 90 and 92 but attached directly to the window 12 by suction cup 14 so that the window itself provides a trapping of air between the cavity 84 and the window 12. An opaque shroud 96 such as a cardboard box or the like may be placed over flanges 73 of the tri-fold shell 70 providing trapped insulating spaces 97 at the top and bottom of the toy and 98 to its rear. The opaque quality of the shroud 96 ensures complete capture of solar influx.

I claim:

1. A solar-powered molding toy comprising a housing providing a heat retaining volume holding a mold, the mold including at least one cavity that may receive and hold wax fragments, the housing further having at least one light passing surface for admitting sunlight into the heat retaining volume, whereby heat from the sun may raise the temperature of the heat retaining volume sufficiently to cause a fusing of the wax fragments into a new solid figure.

2. The modeling toy of claim 1 wherein the mold is substantially crayon shaped.

3. The modeling toy of claim 1 wherein the light passing surface includes a pair of transparent opposed wall providing a thermally insulating air layer therebetween.

4. The modeling toy of claim 1 where the housing is thermoformable plastic sheet.

5. The modeling toy of claim 1 including further a suction cup and wherein the housing includes an attachment means allowing the suction cup to support the housing against the inner surface a window with the light passing surface adjacent to the window.

6. The modeling toy of claim 1 wherein the mold is an electrometric material.

7. The modeling toy of claim 1 wherein the mold is a thermoformable plastic sheet.

8. The modeling toy of claim 1 including further a shroud fitting over the portions of the housing other than the light passing surface.

9. The modeling toy of claim 1 wherein the shroud is sized to fit over the housing spaced apart therefrom to trap an insulating layer between the shroud and housing.

10. The modeling toy of claim 1 wherein the housing is opaque.

11. A method of recycling broken crayons comprising the steps of:
(a) placing the broken crayons in a mold;
(b) enclosing the mold in a heat retaining volume having at least one transparent surface; and
(c) exposing the transparent surface to sun from the sun may raise the temperature of the heat retaining volume sufficiently to cause a fusing of the broken crayons into a new solid crayon.
